(19) United States
(12) Patent Application Publication
(10) Pub. No.: US 2026/0021735 A1
(43) Pub. Date: Jan. 22, 2026

(54) VEHICLE CHARGING

(71) Applicant: Ford Global Technologies, LLC, Dearborn, MI (US)

(72) Inventors: Dominique Meroux, Ann Arbor, MI (US); Kai Wu, Pittsburgh, PA (US); Aref Ghaderi, East Lansing, MI (US); Venkatarao Rebba, Dearborn, MI (US); Madagedara Maduka Balasooriya, Inkster, MI (US); Ruoxi Wen, Indianapolis, IN (US); Najibesadat Sadatijafarkalaei, McKinney, TX (US); Hyongju Park, Ann Arbor, MI (US)

(73) Assignee: Ford Global Technologies, LLC, Dearborn, MI (US)

(21) Appl. No.: 18/774,979

(22) Filed: Jul. 17, 2024

(51) Int. Cl. B60L 53/62; B60L 53/63; B60L 53/66

(52) U.S. Cl. CPC B60L 53/62; B60L 53/63; B60L 53/66

(57) ABSTRACT

A charging update request for charging a vehicle by a charging station is input to a large language model. Updated vehicle charging parameters are output from the large language model based on the charging update request. Upon determining that the charging update request is permitted for the charging station, power is drawn from the charging station based on the updated vehicle charging parameters.

Electric vehicles require batteries to be recharged, which can be done at public charging stations. Technology is emerging for the architecture and operation of charging station systems. For example, charging station systems can include various types of charging stations such as Level 1 chargers, Level 2 chargers, Direct current fast chargers (DCFC), etc. Level 1 charges can use a 120-volt alternating current (AC) outlet, which can charge a vehicle from 0% state of charge to 80% state of charge (i.e., a relative value indicating how much energy remains in the battery compared to a maximum capacity) in 40-50 hours (e.g., based on a 40-50 kWh battery). Level 2 chargers can use a 240-volt AC outlet, which can charge a vehicle from 0% state of charge to 80% state of charge in 4-10 hours. DCFC can use a direct current (DC) outlet, which can charge a vehicle from 0% state of charge to 80% state of charge in 1 hour or less.

### BRIEF DESCRIPTION OF THE DRAWINGS

FIG. 1 is a block diagram of an example vehicle control system.

FIG. 2 is a block diagram of an example charging station system.

FIG. 3 illustrates a block diagram of an example large language model (LLM).

FIG. 4A a first part of a flowchart of an example process for charging a vehicle at a charging station.

FIG. 4B is a second part of the flowchart of FIG. 4B.

### DESCRIPTION

The present disclosure describes systems and methods for a large language model to update vehicle charging parameters. Typically, vehicle charging parameters are specified to draw power from a charging station at a maximum transfer rate (i.e., a rate (e.g., kilowatts (kW)) at which power is transferred from the charging station to the vehicle) specified for the charging station. However, charging the vehicle at a different transfer rate may be preferable to charging the vehicle at the maximum transfer rate for the charging station given various factors (e.g., an amount of time prior to a user's expected return to the vehicle, an exchange rate (i.e., a price (e.g., dynamic pricing, tiered rates, peak and off-peak, etc.) to transfer a specified amount of electricity (e.g., one kW) given a current time of day, a queue of vehicles at the charging station, and/or time-dependent emissions (e.g., marginal emissions rate from additional power consumption given time and geographic location), etc.).

As disclosed herein, a large language model can output vehicle charging parameters, including updated parameters (i.e., that update prior or default parameters) based on a charging update request. Upon determining that the updated vehicle charging parameters are permitted for a charging station, a computer in a vehicle can actuate vehicle components to draw power from the charging station based on the updated vehicle charging parameters. Drawing power based on the updated vehicle charging parameters can provide charging (i.e., transferring power to) the vehicle at a reduced transfer rate, which can reduce degradation of a vehicle battery.

A system includes a computer including a processor and a memory, the memory storing instructions executable by the processor to input, to a large language model, a charging update request for charging a vehicle by a charging station. The instructions further include instructions to output, from the large language model, updated vehicle charging parameters based on the charging update request. The instructions further include instructions to, upon determining that the charging update request is permitted for the charging station, draw power from the charging station based on the updated vehicle charging parameters.

The instructions can further include instructions to, upon determining that the charging update request is not permitted for the charging station, draw power from the charging station based on default vehicle charging parameters. The instructions can further include instructions to output, from the large language model, an explanation statement identifying reasons the charging update request is not permitted.

The instructions can further include instructions to determine whether the charging update request is permitted for the charging station based on at least one of a charging end time and a vehicle battery parameter.

The instructions can further include instructions to identify, via the large language model, a charging condition based on vehicle sensor data. The instructions can further include instructions to output, from the large language model, an explanation statement identifying that a source of the charging condition is the vehicle or the charging station. The instructions can further include instructions to output, from the large language model, an identification statement identifying an unoccupied charging station based on the source being the charging station. The instructions can further include instructions to adjust, via the large language model, the updated vehicle charging parameters based on the charging condition.

The instructions can further include instructions to, upon determining that the charging update request is not permitted for the charging station, output, from the large language model, adjusted vehicle charging parameters based on the charging update request. The instructions can further include instructions to output, from the large language model, a recommendation statement identifying the adjusted vehicle charging parameters.

The instructions can further include instructions to, upon inputting, to the large language model, a response indicating acceptance of the recommendation statement, draw power from the charging station based on the adjusted vehicle charging parameters.

A method includes inputting, to a large language model, a charging update request for charging a vehicle by a charging station. The method further includes outputting, from the large language model, updated vehicle charging parameters based on the charging update request. The method further includes, upon determining that the charging update request is permitted for the charging station, drawing power from the charging station based on the updated vehicle charging parameters.

The method can further include, upon determining that the charging update request is not permitted for the charging station, drawing power from the charging station based on default vehicle charging parameters. The method can further include outputting, from the large language model, an explanation statement identifying reasons the charging update request is not permitted.

The method can further include determining whether the charging update request is permitted for the charging station based on at least one of a charging end time and a vehicle battery parameter.

The method can further include identifying, via the large language model, a charging condition based on vehicle sensor data. The method can further include outputting, from the large language model, an explanation statement identifying that a source of the charging condition is the vehicle or the charging station. The method can further include outputting, from the large language model, an identification statement identifying an unoccupied charging station based on the source being the charging station. The method can further include adjusting, via the large language model, the updated vehicle charging parameters based on the charging condition.

The method can further include, upon determining that the charging update request is not permitted for the charging station, outputting, from the large language model, adjusted vehicle charging parameters based on the charging update request. The method can further include outputting, from the large language model, a recommendation statement identifying the adjusted vehicle charging parameters.

The method can further include, upon inputting, to the large language model, a response indicating acceptance of the recommendation statement, drawing power from the charging station based on the adjusted vehicle charging parameters.

Further disclosed herein is a computing device programmed to execute any of the above method steps. Yet further disclosed herein is a computer program product, including a computer readable medium storing instructions executable by a computer processor, to execute an of the above method steps.

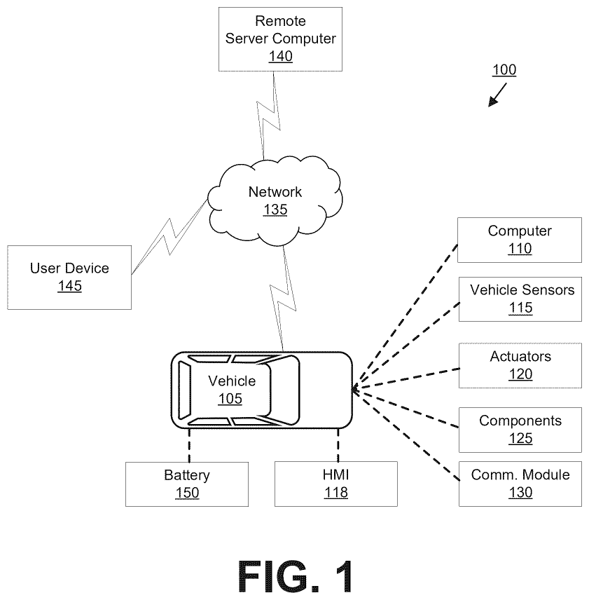

With reference to FIGS. 1-3, an example vehicle control system 100 includes a vehicle 105. The vehicle 105 may be any type of vehicle 105 with two or more wheels (e.g., a motorcycle or motorbike, passenger or commercial automobile such as a sedan, a coupe, a truck, a sport utility, a crossover, a van, a minivan, a taxi, a bus, etc.) that includes batteries that can be recharged by a charging station 205, as described further below.

A vehicle computer 110 in the vehicle 105, receives data from sensors 115. The vehicle computer 110 is programmed to input, to a large language model, a charging update request for charging the vehicle 105 by a charging station 205. The vehicle computer 110 is further programmed to output, from the large language model, updated vehicle charging parameters based on the charging update request. The vehicle computer 110 is further programmed to, upon determining that the charging update request is permitted for the charging station, draw power from the charging station 205 based on the updated vehicle charging parameters.

Referring to FIG. 1, the vehicle 105 includes the vehicle computer 110, the sensors 115, actuators 120 to actuate various vehicle components 125, and a vehicle communications module 130. The communications module 130 allows the vehicle computer 110 to communicate with a remote server computer 140, and/or other vehicles (e.g., via a messaging or broadcast protocol such as Dedicated Short Range Communications (DSRC), cellular, and/or other protocol that can support vehicle-to-vehicle, vehicle-to infrastructure, vehicle-to-cloud communications, or the like, and/or via a packet network 135).

The vehicle computer 110 includes a processor and a memory. The memory includes one or more forms of computer-readable media, and stores instructions executable by the vehicle computer 110 for performing various operations, including as disclosed herein. The vehicle computer 110 can further include two or more computing devices operating in concert to carry out vehicle 105 operations including as described herein. Further, the vehicle computer 110 can be a generic computer with a processor and memory as described above, and/or may include an electronic control unit (ECU) or electronic controller or the like for a specific function or set of functions, and/or may include a dedicated electronic circuit including an ASIC that is manufactured for a particular operation (e.g., an ASIC for processing sensor data and/or communicating the sensor data). In another example, the vehicle computer 110 may include an FPGA (Field-Programmable Gate Array) which is an integrated circuit manufactured to be configurable by a user. Typically, a hardware description language such as VHDL (Very High Speed Integrated Circuit Hardware Description Language) is used in electronic design automation to describe digital and mixed-signal systems such as FPGA and ASIC. For example, an ASIC is manufactured based on VHDL programming provided pre-manufacturing, whereas logical components inside an FPGA may be configured based on VHDL programming, (e.g., stored in a memory electrically connected to the FPGA circuit). In some examples, a combination of processor(s), ASIC(s), and/or FPGA circuits may be included in the vehicle computer 110.

The vehicle computer 110 may operate and/or monitor the vehicle 105 including controlling and/or monitoring components 125. The vehicle computer 110 may include programming to operate one or more of vehicle propulsion, steering, transmission, climate control, interior and/or exterior lights, horn, doors, etc., as well as to determine whether and when the vehicle computer 110, as opposed to a human operator, is to control such operations. Additionally, the computer may be programmed to determine whether and when a human operator is to control such operations.

The vehicle computer 110 may include or be communicatively coupled to (e.g., via a vehicle communications network such as a communications bus as described further below), more than one processor (e.g., included in electronic controller units (ECUs) or the like) included in the vehicle 105 for monitoring and/or controlling various vehicle components 125 (e.g., a transmission controller, a steering controller, etc.). The vehicle computer 110 is generally arranged for communications on a vehicle communication network that can include a bus in the vehicle 105 such as a controller area network (CAN) or the like, and/or other wired and/or wireless mechanisms.

Via the vehicle 105 network, the vehicle computer 110 may transmit messages to various devices in the vehicle 105 and/or receive messages (e.g., CAN messages) from the various devices (e.g., sensors 115, an actuator 120, ECUs, etc.). Alternatively, or additionally, in cases where the vehicle computer 110 actually comprises a plurality of devices, the vehicle communication network may be used for communications between devices represented as the vehicle computer 110 in this disclosure. Further, as mentioned below, various controllers and/or sensors 115 may provide data to the vehicle computer 110 via the vehicle communication network.

Vehicle 105 sensors 115 may include a variety of devices such as are known to provide analog and/or digital data measuring or describing physical phenomena. “Data” herein means information that can be processed and/or stored by a digital computer. Data can be provided and/or represented in a variety of formats (e.g., binary, hexadecimal, alphanumeric, e.g., ASCII, etc.). A sensor herein means a device that can obtain data including one or more measurements of one or more physical phenomena. Vehicle sensors 115 could include cameras, lidar, radar, ultrasonic sensors, and various other sensors, including as described by way of example as follows. Some vehicle sensors 115 detect internal states of the vehicle 105, for example, wheel speed, wheel orientation, and engine and transmission variables. Some vehicle sensors 115 detect the position or orientation of the vehicle 105, for example, global positioning system GPS sensors; accelerometers such as piezo-electric or microelectromechanical systems MEMS; gyroscopes such as rate, ring laser, or fiber-optic gyroscopes; inertial measurements units IMU; and magnetometers. Some sensors 115 detect the external world, for example, radar sensors, scanning laser range finders, light detection and ranging LIDAR devices, and image processing sensors such as cameras. A LIDAR device detects distances to objects by emitting laser pulses and measuring the time of flight for the pulse to travel to the object and back. In the context of this disclosure, an object is a physical (i.e., material) item that has mass and that can be represented by physical phenomena (e.g., light or other electromagnetic waves, or sound, etc.) detectable by sensors 115. Thus, the vehicle 105, as well as other items including as discussed below, fall within the definition of “object” herein.

Some sensors 115 are communications devices, for example, vehicle-to-infrastructure (V2I) or vehicle-to-vehicle (V2V) devices. Sensor operation can be affected by obstructions (e.g., dust, snow, insects, etc.). Often, but not necessarily, a sensor 115 includes a digital-to-analog converter to converted sensed analog data to a digital signal that can be provided to a digital computer (e.g., via a network). Sensors 115 can include a variety of devices, and can be disposed to sense an environment, provide data about a machine, etc., in a variety of ways. For example, the sensors 115 can be mounted to any suitable location in or on the vehicle 105 to collect image data of the environment around the vehicle 105. Image data herein means digital image data (e.g., comprising pixels with intensity and color values) that can be acquired by camera sensors 115.

Moreover, various controllers in a vehicle 105 may operate as vehicle sensors 115 to provide data via the vehicle network or bus (e.g., data relating to vehicle 105 speed, location, subsystem and/or component 125 status, etc.). Further, other sensors 115 could include cameras, short range radar, long range radar, LIDAR, and/or ultrasonic transducers, weight sensors, accelerometers, motion detectors, etc. (i.e., sensors to provide a variety of data). The vehicle computer 110 is programmed to receive data from one or more sensors 115 substantially continuously, periodically, and/or when instructed by a remote server computer 160, etc. To provide just a few non-limiting examples, sensor data could include data for determining a position of a component 125, a location of an object, a speed of an object, a type of an object, a slope of a roadway or surface of an area, a temperature, a presence or amount of moisture, a data rate, etc. Location data specifies a point or points on a ground surface and may be in a known form (e.g., geo-coordinates such as latitude and longitude coordinates obtained via a navigation system, as is known, that uses the Global Positioning System (GPS)).

The vehicle 105 actuators 120 are implemented via circuits, chips, or other electronic and/or mechanical components that can actuate various vehicle subsystems in accordance with appropriate control signals as is known. The actuators 120 may be used to control components 125 to operate a vehicle 105.

In the context of the present disclosure, a vehicle component 125 is one or more hardware components adapted to perform a mechanical or electro-mechanical function or operation—such as moving the vehicle 105, slowing or stopping the vehicle 105, steering the vehicle 105, etc. Non-limiting examples of components 125 include a propulsion component (that includes, e.g., an internal combustion engine and/or an electric motor, etc.), a transmission component, a steering component (e.g., that may include one or more of a steering wheel, a steering rack, etc.), a suspension component (e.g., that may include one or more of a damper (e.g., a shock or a strut), a bushing, a spring, a control arm, a ball joint, a linkage, etc.), a park assist component, an adaptive cruise control component, an adaptive steering component, etc.

The vehicle 105 further includes a human-machine interface (HMI) 118. The HMI 118 includes user input devices such as knobs, buttons, switches, pedals, levers, touchscreens, and/or microphones, etc. The input devices may include sensors 115 to detect a user input and provide user input data to the vehicle computer 110. That is, the vehicle computer 110 may be programmed to receive user input from the HMI 118. The occupant may provide the user input via the HMI 118 (e.g., by selecting a virtual button on a touchscreen display, by providing voice commands, etc.). For example, a touchscreen display included in an HMI 118 may include sensors 115 to detect that an occupant selected a virtual button on the touchscreen display to, for example, select or deselect an operation, which input can be received in the vehicle computer 110 and used to determine the selection of the user input.

The HMI 118 typically further includes output devices such as displays (including touchscreen displays), speakers, and/or lights, etc., that output signals or data to the occupant. The HMI 118 is coupled to the vehicle communication network and can send and/or receive messages to/from the vehicle computer 110 and other vehicle sub-systems.

The vehicle 105 further includes a battery 150. The battery 150 provides power (i.e., electricity) to the vehicle components 125 and the sensors 115 of the vehicle 105. The battery 150 can be (e.g., a lead-acid battery, a lithium-ion battery, a set of battery arrays, etc.). One or more power networks can supply power from the battery 150 to the components 125 and sensors 115.

The battery 150 has a state of charge that can vary between 0% (no remaining charge) and 100% (fully charged). The vehicle computer 110 can determine the state of charge of the battery 150 based on sensor 115 data. For example, the vehicle computer 110 can receive data from various sensors 115 indicating current flowing through the battery 150 and a temperature of the battery 150. The vehicle computer 110 can then determine the state of charge of the battery 150 based on the current and temperature (e.g., using an electrochemical battery model). A state of charge of the battery 150 typically specifies an amount of electrical energy stored in the battery 150. The state of charge is a level of charge of the battery 150 relative to a capacity of the battery 150. The capacity of a battery 150 is a maximum quantity of charge that the battery 150 can store. The capacity of the battery 150 may be specified in units of electrical charge (e.g., ampere-hours). The state of charge as a percentage is equal to the remaining units of charge divided by the capacity of the battery 150.

The vehicle computer 110 may further be configured for communicating via a vehicle-to-vehicle communication module 130 or interface with devices outside of the vehicle 105 (e.g., through a vehicle-to-vehicle (V2V) or vehicle-to-infrastructure (V2X) wireless communications (cellular and/or short-range radio communications, etc.)) to another vehicle, and/or to a remote server computer 160 (typically via direct radio frequency communications). The communications module 130 could include one or more mechanisms, such as a transceiver, by which the computers of vehicles may communicate, including any desired combination of wireless (e.g., cellular, wireless, satellite, microwave and radio frequency) communication mechanisms and any desired network topology (or topologies when a plurality of communication mechanisms are utilized). Exemplary communications provided via the communications module 130 include cellular, Bluetooth, IEEE 802.11, dedicated short range communications (DSRC), cellular V2X (CV2X), and/or wide area networks (WAN), including the Internet, providing data communication services. The label “V2X” is used herein for communications that may be vehicle-to-vehicle (V2V) and/or vehicle-to-infrastructure (V2I), and that may be provided by communication module 130 according to any suitable short-range communications mechanism (e.g., DSRC, cellular, or the like).

The network 135 represents one or more mechanisms by which a vehicle computer 110 may communicate with remote computing devices (e.g., the remote server computer 140, another vehicle computer, a user device 145, etc.). Accordingly, the network 135 can be one or more of various wired or wireless communication mechanisms, including any desired combination of wired (e.g., cable and fiber) and/or wireless (e.g., cellular, wireless, satellite, microwave, and radio frequency) communication mechanisms and any desired network topology (or topologies when multiple communication mechanisms are utilized). Exemplary communication networks include wireless communication networks (e.g., using Bluetooth®, Bluetooth® Low Energy (BLE), IEEE 802.11, vehicle-to-vehicle (V2V) such as Dedicated Short Range Communications (DSRC), etc.), local area networks (LAN) and/or wide area networks (WAN), including the Internet, providing data communication services.

The remote server computer 140 can be a conventional computing device (i.e., including one or more processors and one or more memories) programmed to provide operations such as disclosed herein. Further, the remote server computer 160 can be accessed via the network 135 (e.g., the Internet, a cellular network, and/or or some other wide area network).

The user device 145 can be a conventional computing device (i.e., including one or more processors and one or more memories) programmed to provide operations such as disclosed herein. The user device 145 can be a portable device. A portable device can be any one of a variety of computers that can be used while carried by a person (e.g., a smartphone, a tablet, a personal digital assistant, a smart watch, a key fob, etc.). Further, the user device 145 can be accessed via the network 135 (e.g., the Internet, a cellular network, and/or or some other wide area network).

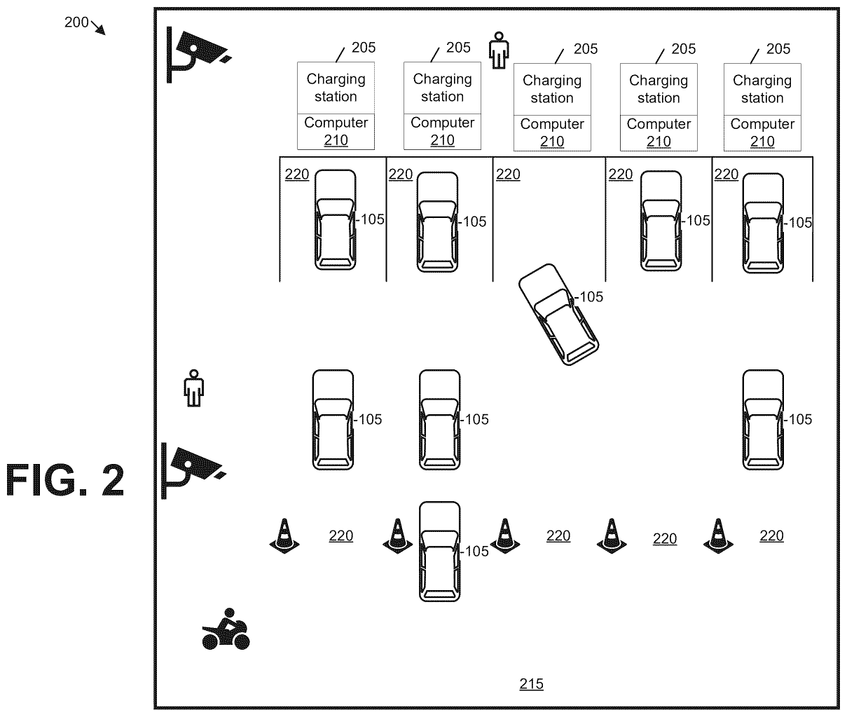

Turning now to FIG. 2, an exemplary architecture for a vehicle charging station system 200 can provide one or more charging stations 205 to accommodate vehicles 105 with electric batteries to be recharged. Each charging station 205 includes a physical structure on or in which sensors (not shown), as well as a communications module (not shown), and a computer 210 can be housed, mounted, stored, and/or contained, and powered, etc. The charging station 205 typically stationary (i.e., fixed to and not able to move from a specific physical location). The respective one or more charging stations 205 in the charging station system 200 can use any suitable mechanism for recharging batteries of vehicles 105 (e.g., a plug-in connection, inductive charging, etc.).

The sensors, communication module, and computer 210 typically have features in common with the sensors 115, the vehicle computer 110 and the vehicle communications module 130, and therefore will not be described further to prevent redundancy. Although not shown for ease of illustration, the charging station 205 also includes a power source such as a battery, solar power cells, and/or a connection to a power grid.

An area 215 of the charging station system 200 can be defined (e.g., as a perimeter, an illustrative example of which is the rectangle shown encompassing other elements described in FIG. 2) encompassing the charging stations 205 and other elements of the charging station system 200. The area 215 can include one or more sub-areas 220 corresponding to respective charging stations 205. That is, the sub-areas 220 are provided as areas in which vehicles 105 can be parked while receiving electrical charge for their batteries from a respective charging station 205. The charging station system area 215 can also include a region in which vehicles 105 may park and/or travel (e.g., while awaiting access to a charging station 205) to park to visit some other facility of the charging station 205, to enter and exit the area 215, etc. The area 215 and sub-areas 220 of the charging station system 200, and any other regions thereof, can be defined according to location coordinates, a geo-fence, or any other suitable manner of defining location boundaries.

The charging station system 200 can include a plurality of stationary sensors (not numbered), whether mounted to specific charging stations 205 and/or with fields of view of specific sub-areas 220, or independent of any specific sub-area 220, and with fields of view including portions of the area 215 other than, or in addition to, including one or more sub-areas 220. For example, the charging station system 200 typically includes one or more sensors (e.g., still and/or video cameras, lidars, radars, ultrasonic sensors, etc.) mounted with respective fields of view so as to cover some or all of the area 215 other than or in addition to the sub-areas 220.

The vehicle computer 110 can be programmed to identify a charging station 205 for re-charging the battery 150 of the vehicle 105. The vehicle computer 110 may, for example, detect, via the HMI 118, a charging request for charging the battery 150. The HMI 118 may, for example, receive a user input selecting a button (e.g., a virtual button displayed on a touchscreen) specifying the charging request. As another example, the HMI 118 may receive an audio sample (e.g., via a microphone) including speech from a user specifying the charging request (e.g., “where's the nearest charging station 205?”, “the battery charge looks a little low,” “does the battery have enough charge to reach the destination?”, etc.). As yet another example, the user device 145 may receive the charging request (e.g., via a user input or an audio sample). In this situation, the user device 145 may transmit (e.g., via the network 135) the charging request to the vehicle computer 110.

Alternatively, the vehicle computer 110 may determine the charging request based on the state of charge of the battery 150 being below a threshold state of charge. The threshold state of charge may be determined based on a path of the vehicle 105. That is, the vehicle computer 110 can determine the threshold state of charge dynamically. The threshold state of charge specifies a minimum state of charge needed to operate the vehicle 105 to a destination along the path (e.g., based on a speed of the vehicle 105, an ambient temperature, traffic along the path, etc.).

The vehicle computer 110 can determine whether the charging request is complete or incomplete. A complete charging request includes specified data. An incomplete charging request lacks at least some of the specified data. The specified data is data defining parameters of the charging request. The specified data may be stored in a look-up table, or the like, that associates the various data with various information included in the charging request. The look-up table may be stored (e.g., in a memory of the vehicle computer 110). The specified data may be specified by a manufacturer of the vehicle 105 and/or an owner/operator of a charging station 205 (e.g., based on determining compatibility between the vehicle 105 and the charging station 205 to perform a charging operation and/or determining (e.g., based on various user feedback) desirable amenities and/or features associated with various areas 215).

As an example, the vehicle computer 110 can compare the charging request to the data stored in the look-up table to determine whether the charging request includes information associated with the various data. If the vehicle computer 110 determines the charging request based on the state of charge of the battery or detects a user input specifying the charging request, then the charging request may be complete. If the vehicle computer 110 detects an audio sample specifying the charging request, then the vehicle computer 110 can convert the audio sample (e.g., according to voice to text techniques) to a text string. The vehicle computer 110 can then parse the text string (e.g., according to natural language processing techniques) to identify the information included in the charging request. If the text string includes information associated with the various data, then the vehicle computer 110 determines that the charging request is complete. If the text string does not include information associated with at least some of the data, then the vehicle computer 110 determines that the charging request is incomplete. In this situation, the vehicle computer 110 can actuate the HMI 118 (e.g., a display and/or a speaker) to output a message to the user indicating that the charging request is incomplete and request additional information (e.g., the information associated with at least some of the data that was not included in the charging request).

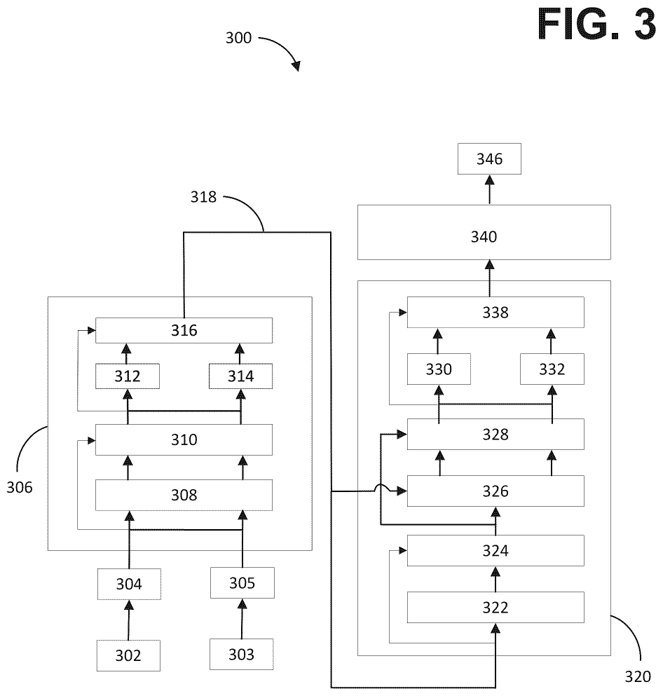

The vehicle computer 110 can then input the complete charging request to a large language model (LLM) 300 (see FIG. 3) trained to operate as a virtual assistant for the user of the vehicle 105 by processing inputs and generating output text that responds to the input in a human-like manner. Alternatively, the vehicle computer 110 can input the charging request to the LLM 300, and the LLM 300 can output text requesting additional information based on determining that the charging request lacks information associated with at least some of the various data specified in the look-up table. The LLM 300 can be trained based on a training dataset that includes map data, vehicle operating parameters (as discussed below), vehicle sensor data, and/or charging operation data. Once trained, the LLM 300 can have a dialogue with the user (e.g., to assist with identifying available charging stations 205, identifying a presence of a charging condition (as discussed below), recommending updated vehicle operations to reduce battery degradation, etc.) to assist the user as the user operates the vehicle 105.

The LLM 300 generates an output text that identifies an area 215 for charging the vehicle 105. The LLM 300 can identify the area 215 based on various parameters (i.e., measurable factors defining criteria) for identifying areas for vehicle charging. The parameters can be stored (e.g., in a memory of the vehicle computer 110). Non-limiting examples of parameters include locations of areas 215 (e.g., relative to the path of the vehicle 105), amenities available in the areas 215, rates of charging station 205 downtime (i.e., an amount of time that the charging stations 205 in the area 215 are inoperable relative to an amount of time that the charging stations 205 in the area are operable), user reviews of the area 215 (e.g., provided via the Internet, mobile applications, etc.), whether the vehicle 105 has previously re-charged the battery 150 in the area 215, and environmental factors (e.g., wind, precipitation, time of day, fog, etc.).

Upon receiving the identification of the area 215 from the LLM 300, the vehicle computer 110 can transmit (e.g., via the network 135) a request to the remote server computer 140 (or the computer 210) to determine a presence of an available charging station 205 (i.e., a charging station 205 adjacent to a sub-area 220 that is not occupied by another vehicle) within the area 215. The remote server computer 140 (or the computer 210) can determine whether a charging station 205 is available (as described further below). Upon receiving a response (e.g., via the network 135) from the remote server computer 140 indicating a presence of an available charging station 205, the vehicle computer 110 can input the response to the LLM 300. The LLM can output an identification statement identifying an available charging station 205 in the identified area 215 (e.g., “there is a charging station two miles ahead and on the right.”). The vehicle computer 110 can then provide the identification statement to the user (e.g., via a speaker and/or a display included in the HMI 118, via a display included in the user device 145, etc.). The response may further specify a maximum charging rate of the available charging station 205.

Additionally, the LLM 300 can output text that may include an inquiry to reserve the available charging station 205 (e.g., “do you want to reserve the charging station 205?”). The vehicle computer 110 can detect a reservation request (e.g., via the HMI 118 or the user device 145, as discussed above) to reserve the charging station 205 in a same manner as described above regarding detecting the charging request. The reservation request (e.g., “yes”) may be detected, for example, in response to the inquiry. As another example, the reservation request (e.g., “can you please reserve the charging station 205?”) may be detected prior to the vehicle computer 110 providing the inquiry to the user (e.g., via a speaker and/or a display included in the HMI 118, via a display included in the user device 145, etc.). The vehicle computer 110 can then input the reservation request to the LLM 300 that outputs an estimated charging start time (e.g., determined based on the path of the vehicle 105, the speed of the vehicle 105, a distance between the vehicle 105 and the charging station 205 determined along the path, traffic along the path, etc.) and/or an estimated charging duration (e.g., determined based on an estimated state of charge of the vehicle 105 at the estimated start time, a maximum charging rate of the available charging station 205, an ambient temperature, etc.) The vehicle computer 110 can transmit (e.g., via the network 135), to the computer 140, 210, the reservation request including the estimated charging start time and/or the estimated charging duration. The computer 140, 210 can be programmed to determine whether the reservation request is permitted or not permitted (as described further below).

Upon receiving a response from the computer 140, 210 indicating whether the reservation request is permitted or not, the vehicle computer 110 can then input the response to the LLM 300 that outputs a reservation statement. The reservation statement indicates whether the charging station 205 is reserved for the vehicle 105 (e.g., “the charging station is reserved for the next sixty minutes.”, “the charging station is unable to be reserved (for the next 45 minutes).”, etc.). If the charging station 205 is not reserved, then the reservation statement may include reasons indicating why the charging station 205 is not reserved (e.g., reservations are not permitted (e.g., due to a queue length in the area 215, based on the time of day, etc.), another reservation conflicts with the requested reservation, etc.). The vehicle computer 110 can provide the reservation statement to the user (e.g., via a speaker and/or a display included in the HMI 118, via a display included in the user device 145, etc.). Additionally, the vehicle computer 110 can input the reservation request and the response indicating that the reservation requested is not permitted to the LLM 300 that outputs an updated reservation request (e.g., including an updated estimated charging start time and/or estimated charging duration). The vehicle computer 110 can then request to reserve the charging station 205 based on the updated reservation request in the same manner as just described.

Upon receiving a response indicating that no charging stations 205 are available in the area 215, the vehicle computer 110 can input the response to the LLM 300 that can output text that recommends to continue to the area 215 or identifies an alternative area 215 for re-charging the vehicle 105 battery 150 (e.g., “although no charging stations are currently available, please continue to the area and wait.”, “would you like to identify a different charging area?”, “another available charging station is 45 miles ahead on the left.”, etc.). The vehicle computer 110 can provide the output text to the user in the same manner as discussed above regarding providing outputs from the LLM 300 to the user.

The vehicle computer 110 can generate a planned path to operate the vehicle 105 to the area 215 (or alternative area 215). Specifically, the vehicle computer 110 can operate the vehicle 105 to a sub-area 220 within the area 215. The sub-area 220 can be adjacent to an available charging station 205 or can be a designated area for stopping the vehicle 105 while waiting in a queue to access available charging stations 205. The vehicle computer 110 can actuate one or more vehicle components 125 to operate the vehicle 105 along the planned path.

As used herein, a “path” is a set of points, (e.g., that can be specified as coordinates with respect to a vehicle coordinate system and/or geo-coordinates, that the vehicle computer 110 is programmed to determine with a conventional navigation and/or path planning algorithm). A path can be specified according to one or more path polynomials. A path polynomial is a polynomial function of degree three or more that describes the motion of a vehicle on a ground surface. Motion of a vehicle on a roadway is described by a multi-dimensional state vector (e.g., that includes vehicle location, orientation, speed, etc.) determined by fitting a polynomial function to successive 2D locations included in the vehicle motion vector with respect to the ground surface, for example.

Further for example, the path polynomial p (x) is a model that predicts the path as a line traced by a polynomial equation. The path polynomial p (x) predicts the path for a predetermined upcoming distance x, by determining a lateral coordinate p, (e.g., measured in meters):

$$p ( x ) = {a}_{0} + {a}_{1} x + {a}_{2} {x}^{2} + {a}_{3} {x}^{3} \qquad ( 1 )$$

where a₀ an offset (i.e., a lateral distance between the path and a center line of the vehicle 105 at the upcoming distance x), a₁ is a heading angle of the path, a₂ is the curvature of the path, and a₃ is the curvature rate of the path.

While operating the vehicle 105 along the planned path, the vehicle computer 110 can identify collected data for the vehicle 105 while operating the vehicle 105 along the road. In this context, “collected data” are data describing movement and positions of vehicles (i.e., collected data are data measuring various vehicle attributes as the vehicle operates). That is, the collected data provide measurements describing how the vehicle 105 operates. The collected data can include, for example, vehicle speed, steering angle, wheel-slip data, yaw, yaw rate, pitch, pitch rate, heading angle, sideslip angle (i.e., an angle of the vehicle's velocity relative to a longitudinal axis of the vehicle), steering wheel torque, a vehicle location, etc.

The collected data can be obtained or derived (e.g., according to known data processing techniques) from sensor 115 data. For example, the sensors 115 can capture data, (e.g., image and/or video data, during operation of the vehicle 105 and transmit the data to the vehicle computer 110). The vehicle computer 110 can then, for example, analyze the sensor 115 data (e.g., using pattern recognition and/or image analysis techniques) to identify the collected data of the vehicle 105. As another example, the sensor 115 data can specify the collected data of the vehicle 105 (e.g., wheel speed sensor 115 data specifying a speed of the vehicle 105).

The vehicle computer 110 can input the collected data, the planned path, and the state of charge of the battery 150 to the LLM 300. The LLM 300 can output text recommending updated operating parameters for the vehicle 105 (e.g., “reducing a rate of speed change can decrease battery degradation,” “reducing a speed of the vehicle by 5 miles (or kilometers) per hour can decrease battery degradation by 15%.”, etc.). The vehicle computer 110 can actuate one or more vehicle components 125 based on the updated operating parameters. As another example, the vehicle computer 110 can provide the output text to the user (e.g., to instruct the user to update vehicle operation based on the updated operating parameters) in the same manner as discussed above regarding providing outputs from the LLM 300 to the user. Operating the vehicle based on the updated operating parameters may increase a likelihood of the vehicle reaching the sub-area 220 prior to the state of charge of the battery 150 reaching 0%.

An operating parameter herein is a physical limit of vehicle 105 operation (i.e., an operating parameter specifies a limit of a measurement of vehicle operation and/or a measurement of an environmental condition limiting vehicle 105 operation). Put another way, an operating parameter is a limit of a measurement of a physical characteristic of a vehicle 105 or an environment around that vehicle 105 while the vehicle 105 operates along a path. A variety of operating parameters may be determined for vehicle operation. A non-limiting list of operating parameters includes a maximum vehicle 105 speed, a rate of change of the vehicle 105 speed, a climate control setting, etc.

Upon entering the area 215, the vehicle computer 110 can, for example, operate the vehicle 105 to the sub-area 220 adjacent to the reserved charging station 205. If the charging station 205 is not reserved, the vehicle computer 110 can identify an available charging station 205 based on sensor 115 data (e.g., in the same manner as discussed above). Upon identifying an available charging station 205, the vehicle computer 110 can operate the vehicle 105 to the sub-area 220 adjacent to the available charging station 205.

If no available charging stations 205 are detected, then the vehicle computer 110 can operate the vehicle 105 to a queue sub-area 220 that is designated for stopping the vehicle 105 (e.g., to wait in a queue). In this situation, the vehicle computer 110 may detect (e.g., via the HMI 118 or the user device 145, as discussed above) an inquiry about a wait time for an available charging station 205 (e.g., “how much time until a charging station is available?”, “how many vehicles are in front of me in the queue?”, etc.). The vehicle computer 110 can receive messages (e.g., via the network 135) from the computers 210 and other vehicle computers 110 indicating a time at which respective vehicles arrived in the queue sub-area 220 and/or an amount of time until the respective vehicles are expected to depart respective sub-areas 220 adjacent to unavailable charging stations 205 (i.e., an amount of time until respective charging stations 205 will become available). The vehicle computer 110 can input the inquiry and the messages to the LLM 300 that can output a statement indicating a position of the vehicle 105 in the queue and/or an expected wait time until a charging station 205 will become available for the vehicle 105 (e.g., “a charging station will be available in twenty minutes.”, “there are five vehicles in front of you in the queue.”, etc.). The vehicle computer 110 can provide the statement to the user in the same manner as discussed above regarding providing outputs from the LLM 300 to the user.

The vehicle computer 110 can collect sensor 115 data of the area 215, including the charging station 205. The vehicle computer 110 can input the sensor 115 data to the LLM 300 that outputs a statement indicating a presence or an absence of a charging condition at the charging station 205. A charging condition is a condition of the charging station 205 or the vehicle 105 that impairs power transfer according to vehicle charging parameters and station charging parameters. For example, the charging station 205 may include an indicator light that is illuminated to display different colors based on whether the charging station is able to provide power according to the station charging parameters. The sensor 115 data may include an image including a representation of the indicator light displaying, for example, one color indicating that the charging station 205 is unable to provide power according to the station charging parameters, or another color indicating that the charging station 205 is able to provide power according to the station charging parameters.

A vehicle charging parameter herein is a physical limit of power transfer to the vehicle 105 (i.e., a vehicle charging parameter specifies a limit of a measurement of power transfer to the vehicle 105). Put another way, a vehicle charging parameter is a limit of a measurement of power transfer from the charging station 205 to the vehicle 105 while the vehicle 105 is charging. Vehicle charging parameters can include a maximum voltage draw, a maximum current draw, etc. A station charging parameter is a physical limit of power transfer from the charging station 205. The station charging parameters can include a minimum voltage supply, a minimum current supply, a minimum transfer rate, etc.

Upon receiving the statement from the LLM 300 indicating a presence of a charging condition at the charging station 205 (e.g., “there is a charging condition present at this charging station.”), the vehicle computer 110 can provide the statement to the user in the same manner as discussed above regarding providing outputs from the LLM 300 to the user. Additionally, the statement can include an inquiry to identify another available charging station 205 (e.g., “would you like to identify another charging station nearby?”). The vehicle computer 110 can detect (e.g., via the HMI 118 or the user device 145, as discussed above) a response to the inquiry (e.g., “yes.”, “please identify another charging station nearby.”, etc.). Based on the response indicating to identify another available charging station 205, the vehicle computer 110 can identify another available charging station 205 (e.g., in the area 215 or in an alternative area 215) in the same manner as discussed above regarding identifying the available charging station 205.

While in the sub-area 220 adjacent to the charging station 205, the user may connect the vehicle 105 to the charging station 205. For example, the user may insert a charging adapter of the charging station 205 into a charging port of the vehicle 105. While connected to the charging station 205, the vehicle computer 110 can detect (e.g., via the HMI 118 or the user device 145, as discussed above) a request to transfer tokens from a computer 110, 140 or the user device 145 to the computer 210 (e.g., “please transfer tokens from my account associated with an entity (e.g., a manufacturer of a vehicle, an owner of a charging station, etc.) to the charging station.”). The vehicle computer 110 can input the request to the LLM 300 that outputs a statement identifying (e.g., via an identifier) a computer 110, 140 or the user device 145. The vehicle computer 110 can provide the tokens to the computer 210, or request (e.g., via the network 135) the remote server computer 140 or user device 145 to provide the tokens to the computer 210. Upon receiving (e.g., via the network 135) the tokens from the computer 110, 140 or the user device 145, the computer 210 can initiate a charging operation. During the charging operation, the computer 210 and the vehicle computer 110 can communicate to actuate components 125 of the vehicle 105 and/or a power source of the charging station 205 to transfer energy from the power source of the charging station 205 to the vehicle 105 battery 150.

In the present context, a “token” is data that represents a number of units of a transferrable object. The unit can be, for example, a unit of currency money, for example, 0.01 cents, 0.1 cents, 1 cent, a unit of virtual currency (or faction thereof), etc., an amount of an object (e.g., size or weight, of a raw material object, such as 1 gram of gold or silver, 1 foot of lumber, etc.). One or more computers 110, 140, 145, 210 can store (e.g., in a memory thereof) the tokens and can transmit the tokens to one or more computers 110, 140, 145, 210. For example, the user device 145, the vehicle computer 110, or another computer associated with a user of the vehicle 105 (e.g., an entity computer remote from the vehicle 105) can store tokens associated with the user.

While connected to the charging station 205, the vehicle computer 110 can receive sensor 115 data regarding the charging operation. For example, the vehicle computer 110 can receive data from sensors 115 included in the vehicle 105. The sensor 115 data may indicate one or more parameters of the charging operations (e.g., a voltage, a current, a transfer rate, etc.).

The vehicle computer 110 can detect (e.g., via the HMI 118 or the user device 145, as discussed above) a charging update request. The vehicle computer 110 can then determine whether the charging update request is complete or incomplete, as discussed above. Upon determining that the charging update request is incomplete, the vehicle computer 110 can output a message requesting additional information, as discussed above. Upon determining that the charging update request is complete, the vehicle computer 110 inputs the complete charging update request to the LLM 300. The LLM 300 outputs updated vehicle charging parameters based on the charging update request. That is, the updated vehicle charging parameters, if achieved, would alter the charging operation to satisfy the charging update request. Alternatively, the vehicle computer 110 can input the charging update request to the LLM 300, and the LLM 300 can output text requesting additional information based on determining that that the charging update request lacks information associated with at least some of the various data specified in the look-up table, as discussed above.

The charging update request may, for example, request to charge the vehicle 105 at a charging rate that is different from a maximum charging rate for the charging station 205 (e.g., “I will be busy for two hours, so reduce the charging rate to complete charging in two hours.”, “adjust the charging rate to minimize carbon-dioxide emissions.”, “just draw power to keep the battery temperature at an optimal temperature.”, etc.). Non-limiting examples of charging update requests include specifying a charging time duration (i.e., an amount of time for the charging operation to complete) that is longer than an expected charging time duration given the maximum charging rate for the charging station 205, delaying a charging start time based on a time of day, minimizing carbon-dioxide emissions (e.g., from a powerplant that provides electricity to the charging station 205) caused by the charging operation, achieve a specified battery 150 temperature, etc. The vehicle computer 110 can detect the charging update request prior to the vehicle 105 being connected to the charging station 205, prior to initiation of the charging operation, or after initiation of the charging operation.

The vehicle computer 110 can determine whether the updated vehicle charging parameters are permitted for the charging station 205. For example, the vehicle computer 110 can input the updated vehicle charging parameters, the station charging parameters, an estimated battery 150 parameter (i.e., measurable factors defining criteria for battery operation and/or performance), and/or an estimated charging end time to the LLM 300 that outputs text indicating whether the updated vehicle charging parameters are permitted or not permitted (e.g., “the charging rate has been adjusted to complete charging in the requested amount of time.”, “the charging rate is unable to be adjusted to accommodate your request.”, etc.). The vehicle computer 110 can provide the output text to the user in the same manner as discussed above regarding providing outputs from the LLM 300 to the user.

As another example, the vehicle computer 110 can determine the estimated charging end time based on the updated vehicle charging parameters. The vehicle computer 110 can, for example, receive (e.g., via the network 135), from the computer 210, a stop time that specifies a time at which the vehicle 105 is no longer permitted to access the charging station 205. The stop time may be determined dynamically (e.g., based on a time of day, a length of a queue in the area 215, another vehicle reserving the charging station 205, etc.). If the estimated charging end time occurs after the stop time, then the vehicle computer 110 determines that the updated vehicle charging parameters are not permitted for the charging station 205. If the estimated charging end time occurs prior to or at the stop time, then the vehicle computer 110 can determine that the updated charging parameters are permitted for the charging station 205.

As another example, the vehicle computer 110 can estimate a parameter of the battery 150 during the charging operation based on the updated vehicle charging parameters. As one example, the parameter may be a temperature (e.g., estimated using an electrochemical battery model). The vehicle computer 110 can then compare the estimated temperature to a temperature threshold. The temperature threshold specifies a maximum temperature of the battery 150 that prevents battery 150 performance from deviating from design specifications. The temperature threshold may be determined empirically (e.g., based on testing/simulation to determine effects of battery temperature on battery performance). The temperature threshold may be stored (e.g., in a memory of the vehicle computer 110). If the estimated temperature exceeds the temperature threshold, then the vehicle computer 110 determines that the updated vehicle charging parameters are not permitted for the charging station 205. If the estimated temperature is less than or equal to the temperature threshold, then the vehicle computer 110 can determine that the updated charging parameters are permitted for the charging station 205. Other non-limiting examples of battery 150 parameters include a maximum battery cell voltage, an internal resistance, a maximum battery cell current, etc.

As yet another example, the vehicle computer 110 can receive (e.g., via the network 135), from the computer 210, the station charging parameters for the charging station 205. The vehicle computer 110 can compare the updated vehicle charging parameters to the station charging parameters for the charging station 205. If at least one updated vehicle charging parameter does not satisfy the respective station charging parameter for the charging station 205, then the vehicle computer 110 determines that the updated vehicle charging parameters are not permitted. If each of the updated vehicle charging parameters satisfies the respective station charging parameters for the charging station 205, then the vehicle computer 110 can determine that the updated vehicle charging parameters are permitted for the charging station 205.

Upon determining that the updated vehicle charging parameters are permitted for the charging station 205, the vehicle computer 110 can draw power from the charging station 205 based on the updated vehicle charging parameters. That is, the vehicle computer 110 can actuate one or more components 125 to receive electricity from the charging station 205 according to the updated vehicle charging parameters.

Based on the updated vehicle charging parameters not being permitted for the charging station 205, the LLM 300 can, for example, output a recommendation statement that indicates adjusted vehicle charging parameters (e.g., “Your request cannot be accommodated. Would you like to complete charging in one hour instead of two hours?”). The adjusted vehicle charging parameters can account for the updated vehicle charging parameters, the station charging parameters, estimated battery 150 parameter(s), and/or the estimated charging end time. That is, the LLM 300 can output adjusted vehicle charging parameters that update the charging operation to approach the charging update request given the station charging parameters, estimated battery 150 parameter(s), and/or the estimated charging end time. The recommendation statement may further include reasons indicating that the adjusted charging parameters approach the charging update request while satisfying requirements of the charging operation (e.g., the station charging parameters, the estimated battery 150 parameter(s), and/or the estimated charging end time).

The vehicle computer 110 can provide the recommendation statement to the user in the same manner as discussed above regarding providing outputs from the LLM 300 to the user. The vehicle computer 110 can detect a response indicating acceptance (e.g., via the HMI 118 or the user device 145, as discussed above) of the recommendation statement (e.g., “Yes, complete charging in the amount of time that you suggested.”). The vehicle computer 110 can then draw power from the charging station 205 based on the adjusted vehicle charging parameters.

Alternatively, the vehicle computer 110 can draw power from the charging station 205 based on default vehicle charging parameters. That is, the vehicle computer 110 can actuate one or more components 125 to receive electricity from the charging station 205 according to the default vehicle charging parameters. The default vehicle charging parameters may be stored (e.g., in a memory of the vehicle computer 110). The default vehicle charging parameters may be determined empirically (e.g., based on testing/simulation to determine vehicle charging parameters that result in the vehicle 105 battery 150 being charged to a specified state of charge (e.g., 80%) within a given amount of time for various types of charging stations 205).

During the charging operation, the vehicle computer 110 can input the sensor 115 data regarding the charging operation to the LLM 300. The LLM 300 can output an explanation identifying a charging condition (e.g., “the vehicle is no longer drawing power from the charging station as expected.”). The explanation statement can further identify a source of the charging condition as one of the vehicle 105 or the charging station 205 (e.g., “The charging station is not providing electricity as expected.”, “The vehicle is not drawing power from the charging station as expected.”, etc.). For example, if the power transfer does not satisfy the vehicle charging parameters (e.g., the vehicle computer 110 pulls voltage and/or current below respective values specified by the vehicle charging parameters), then the explanation statement can identify the source of the charging condition as the vehicle 105. As another example, if the power transfer does not satisfy the station charging parameters (e.g., the charging station 205 provides voltage and/or current below respective values specified by the station charging parameters), then explanation statement can identify the source of the charging condition as the charging station 205. Upon receiving the explanation statement from the LLM 300 indicating an absence of a charging condition, the vehicle computer 110 can continue performing the charging operation based on the (current, adjusted or updated) vehicle charging parameters. Upon identifying a charging condition based on the output from the LLM 300, the vehicle computer 110 can transmit (e.g., via the network 135) a message to the remote server computer 140 identifying the charging condition.

Upon receiving the explanation statement from the LLM 300 indicating a presence of a charging condition and the source being the charging station 205, the vehicle computer 110 can provide the explanation statement to the user in the same manner as discussed above regarding providing outputs from the LLM 300 to the user. Additionally, the explanation statement can include reasons indicating that the charging station 205 is the source of the charging condition (e.g., voltage and/or current is being provide below requested values). Additionally, the LLM 300 can output text including a recommendation to identify another available charging station 205 (e.g., “It would be best to find a new charging station. Would you like me to locate one?”). The vehicle computer 110 can detect a response (e.g., “Yes.”) to the recommendation in the same manner as discussed above. Based on the response indicating acceptance of the recommendation, the vehicle computer 110 can then input the response to the LLM 300 than can output an identification statement identifying an unoccupied charging station in the same manner as discussed above.

Upon receiving the explanation statement from the LLM 300 indicating a presence of a charging condition and the source being the vehicle 105, the vehicle computer 110 can provide the explanation statement to the user in the same manner as discussed above regarding providing outputs from the LLM 300 to the user. Additionally, the explanation statement can include reasons indicating that the vehicle 105 is the source of the charging condition (e.g., voltage and/or current draw is limited due to a current temperature of the battery 150, the charging adaptor is not fully inserted into the charging port, etc.). Additionally, the LLM 300 can output text including recommendations to remedy the charging condition (e.g., to adjust the updated vehicle charging parameters, instruct the user to check on the charging adaptor connection, re-start the charging operation, etc.). The vehicle computer 110 can detect a response to the recommendation and determine whether the charging condition remains present in the same manner as just discussed.

Additionally, or alternatively, the LLM 300 can output text including an inquiry to provide assistance based on identifying the charging condition (e.g., “Would you like me to contact a service provider for assistance?”, “Would you like a mobile charging device to complete the charging operation?”, etc.). The vehicle computer 110 can provide the text to the user in the same manner as discussed above regarding providing outputs from the LLM 300 to the user. The vehicle computer 110 can receive (e.g., via the HMI 118 or the user device 145) a request for assistance in response to the text. The vehicle computer 110 can then transmit (e.g., via the network 135) a message to the remote server computer 140 requesting assistance. The remote server computer 140 can then provide instructions to a remote vehicle to operate to the sub-area 220 to provide assistance (e.g., to provide a mobile charging device that can connect to the vehicle, to transport a technician to provide maintenance/repair services to the vehicle 105 and/or charging station 205, etc.) to the vehicle 105.

As mentioned above, the computer 140, 210 can, for example, identify an available charging station 205 based on sensor data from the sensors in the area 215. For example, the computer 140, 210 can receive (e.g., via the network 135) the sensor data from the sensors in the area 215, and can provide the sensor data to a classifier that comprises programming to utilize one or more conventional image classification techniques. For example, the classifier can use a machine learning technique in which data known to represent various objects, is provided to a machine learning program for training the classifier. Once trained, the classifier can accept as input sensor data (e.g., an image) and then provide as output, for each of one or more respective regions of interest in the image (e.g., the sub-areas 220), an identification and/or a classification of one or more objects or an indication that no object is present in the respective region of interest (e.g., the sub-areas 220). Further, a coordinate system (e.g., polar or cartesian) applied to an area proximate to the sensors can be used to specify locations and/or areas (e.g., according to a sensor coordinate system, translated to global latitude and longitude geo-coordinates, etc.) of objects identified from sensor data. Yet further, the computer 140, 210 could employ various techniques for fusing (i.e., incorporating into a common coordinate system or frame of reference) data from different sensors and/or types of sensors (e.g., lidar, radar, and/or optical camera data). The computer 140, 210 can then transmit (e.g., via the network 135) the response to the vehicle computer 110 indicating that a charging station 205 is available or that no charging stations 205 are available in the area 215.

As mentioned above, the computer 140, 210 can be programmed to determine whether the reservation request is permitted or not permitted, as mentioned above. The computer 140, 210 can determine that the request is permitted based on reservations being permitted (e.g., specified by an entity that owns/operates the charging station 205) and the charging station 205 being available at the estimated charging start time and for the estimated charging duration. If reservations are not permitted for the charging station 205, then the computer 140, 210 determines that the request is not permitted. If reservations are permitted, then the computer 210 can determine that the charging station 205 can be reserved based on various factors such as a time of day, a length of a queue in the area 215 being less than a specified length (e.g., specified by an entity that owns/operates the charging station 205), and/or an absence of a reservation by another vehicle, for the charging station with a charging start time and charging duration that overlaps the estimated charging start time and/or estimated charging duration for the vehicle 105, etc. If the charging station 205 can be reserved, then the computer 140, 210 can reserve the charging station 205 for the vehicle 105 at the estimated charging start time and for the estimated charging duration. The computer 140, 210 can transmit (e.g., via the network 135), to the vehicle computer 110, a response specifying whether the charging station 205 is reserved for the vehicle 105.

FIG. 3 is a diagram of an example LLM 300 which can be based on a transformer neural network. A transformer neural network can be used to implement an LLM 300 because a transformer neural network can handle large amounts of training data efficiently. Training a transformer neural network can result in excess of billions of parameters being stored for recall at inference time. An LLM 300 is a type of neural network optimized for processing sequential data such as natural language. An LLM 300 an attention-based sequence-to-sequence encoder-decoder architecture that can input natural language text, execute instructions included in the input text and output text. Attention-based architectures can process long-range dependencies, where results can be based on words or phrases that are distant from each other in the input data. Attention-based architectures are also good at determining context, where context is defined as underlying circumstances that affect a result output from an LLM 300. Context can be determined based on more than one portion of a sequence input to an LLM 300.

A transformer-based LLM 300 can be trained using very large datasets. For example, an LLM 300 can produce results efficiently by sampling portions of intermediate results generated by the billions of parameters stored as training data. Differences in sampling between one run of an LLM 300 to the next can cause an LLM 300 to be non-deterministic, meaning that an LLM 300 can produce different results for more than one run based on the same input prompt. Although the design of an LLM 300 is such that strictly deterministic behavior is sometimes not possible, careful prompt design can yield results that are close enough to be useable for the desired purpose without being identical. A close result is a result that indicates the same meaning while being expressed with slightly different wording.

A technique for producing repeatable results is to perform multiple LLM 300 runs for a single prompt. Obtaining these results can be compared using a voting algorithm, where the most frequently occurring response is selected. The more detailed and specific examples that are included in a prompt, the more likely similar results will be output for repeated applications of the prompt. The more detailed and specific the input prompts, the less variation in output results will be produced by a trained LLM 300.

LLM 300 includes attention-based processing to efficiently process large input texts and/or images. Attention-based processing can encode text as tokens in a multi-dimensional vector. Relationships between pairs of tokens can be encoded as additional vector dimensions that can connect tokens at any distance within the input text in one step to efficiently encode relationships between words or phrases that can be separated in an input prompt 302. Further, attention-based processing can encode images as patches in a multi-dimensional vector. Relationships between pairs of patches can be encoded as additional vector dimensions that can serially connect patches within the input image in one step to efficiently encode relationships between objects that can be separated in an input prompt 303.

The LLM 300 can receive the input prompt 302 and/or the input prompt 303. The input prompt 302, which is text, is received by a positional encoding block 304, which encodes text as a multi-dimensional vector. The multi-dimensional vector includes tokens which indicate parts of speech and links that indicate relationships between words or phrases in the input text that are related syntactically. Tokens are numeric values that indicate input embedding and positional encoding for words or phrases in the input prompt 302. Input embedding tags the words or phrases in the input prompt with semantic data indicating the part of speech for the words or phrases, such as verb, noun, direct object, indirect object, etc., and positional encoding indicates the positional relationships between tokens in the input prompt 302.

Input prompt 303, which is an image, is received by a vision transformer 305, which encodes the image as a multi-dimensional vector. The multi-dimensional includes patches, which indicates parts of the image, and links that indicate relationships between pixels in the input image. Patches are matrices that indicate patch embedding and positional encoding for pixels in the input prompt 303. Patch embedding tags pixels in the input prompt 303 with semantic data indicating types of objects represented in the pixels, and positional encoding indicates the positional relationship between patches in the input prompt 303.

The LLM 300 includes a transformer encoder 306 followed by a transformer decoder 320. The LLM 300 can include multiple transformer encoders 306 followed by multiple transformer decoders 320. The transformer encoder 306 includes multiple layers which determine, based on parameters determined at training time, relationships between tokens extracted from the human-readable text in the input prompt 302 and relationships between patches extracted from the image in the input prompt 303. The transformer encoder 306 outputs a latent vector 318, so-called because the latent vector 318 is not typically visible outside of the LLM 300. The latent variables 318 are then processed by the transformer decoder 320, which process the tokens or patches and the respective relationships included in the latent variables 318 to generate human-readable text to form output text data 346.

The positionally encoded vector output by positional encoding block 304 or the vision transformer 305 is received by a multi-head attention layer 308 included in the transformer encoder 306. Multi-head attention layer 308 is a self-attention processing layer that generates multiple intermediate results in parallel. Multi-head attention layer 308 permits an LLM 300 to determine results based on multiple intermediate results in a single pass. Generating prompts that emphasize relationships between words in input text or pixels in an image, provides context by describing relationships between words or pixels and generates multiple intermediate results can enhance processing efficiency of an LLM 300 and reduce the effect of non-deterministic behavior of an LLM 300.

Self-attention processing by multi-head attention layer 308 can determine relationships between the tokens or patches in input vector without additional external data. The weights or parameters included in training data for LLM 300 can determine relationships and scores for the relationships between the tokens or patches. Multi-head attention layer 308 can determine multiple relationships and scores between multiple groups of input tokens or patches in the same pass. Multi-head attention layer 308 outputs the relationships and scores to add and norm layer 310 where each of the relationships and scores are separately added to the positionally encoded vector and normalized to keep the data within preset limits, typically 0 to 1. This normalization is performed based on mean and variance values accumulated over the entire training dataset, thereby forcing results to stay within a defined range of values. Normalization prevents anomalous results from skewing the training data, which helps the training converge more quickly on valid results.

The respective multi-head outputs from add and normalize layer 310 are input to multiple feed forward networks 312, 314, where the normalized results are processed in parallel. Feed forward networks 312, 314 are fully connected neural networks that calculate linear and/or non-linear functions based on the input normalized vector data. The output from the feed forward networks 312, 314 is combined with output from the first add and normalize layer 308 at a second add and normalize layer 316. The operation of the second add and normalize layer 316 is the same as described above in relation to the first add and normalize layer 308, where the results are normalized to a selected range, for example 0 to 1, to inhibit anomalous results and enhance training.

Transformer encoder 306 outputs a latent vector 318 to either a subsequent transformer encoder 306 or to transformer decoder 320. Upon the latent vector 318 exiting a final transformer encoder 306, the transformer decoder 320 receives the latent vector 318 at the first decoder attention layer 322 which flattens the input latent vector 318 to compact the number of connections that relate tokens or patches included in latent vector 318. Following the first decoder attention layer 322, first decoder add and normalize layer 324 normalizes the flattened vector data as discussed above to again permit rapid convergence of results during training. Following the first decoder add and normalize layer 324, second multi-head encoder-decoder attention layer 326 combines latent vector 318 with flattened vector output from first add and normalize layer 324. Output from second multi-head encoder-decoder attention layer 326 is input to second decoder add and normalize layer 328 and then to multiple feed forward networks 330, 332 to process each portion of the flattened vector data in parallel. Feed forward networks 330, 332 are fully connected neural networks that calculate linear and/or non-linear functions based on the input flattened vector data. Following the feed forward networks 330, 332 a third decoder add and normalize layer 338 normalizes the output from the feed forward networks 330, 332 as discussed above.

LLM 300 can include multiple transformer decoders 320. Following a final decoder block 320, LLM 300 can include a linear layer 340 which inputs the flattened vector data output by the final transformer decoder 320. Linear layer 340 includes a fully connected neural network that translates the flattened vector data output by the final transformer decoder 320 into output text data 346 for final output.

LLM 300 can be implemented as a software program installed as instructions in memory of the vehicle computer 110, and executable by a processor thereof. LLM 300 can alternatively or additionally be implemented as a software program in the remote server computer 140. Input prompt 302, 303 can be received via HMI 118, a sensor 115, a user device 145, or from the remote server computer 140.

A trained LLM can be installed in a computing device where the LLM can be operated to generate useful output text. Operating a trained LLM can include providing the LLM with a prompt. A prompt is a text file or an image that includes instructions and/or data that determine the processing that will be performed by the LLM. The text that will be output from the LLM following processing is based on the contents of the prompt received by the LLM.

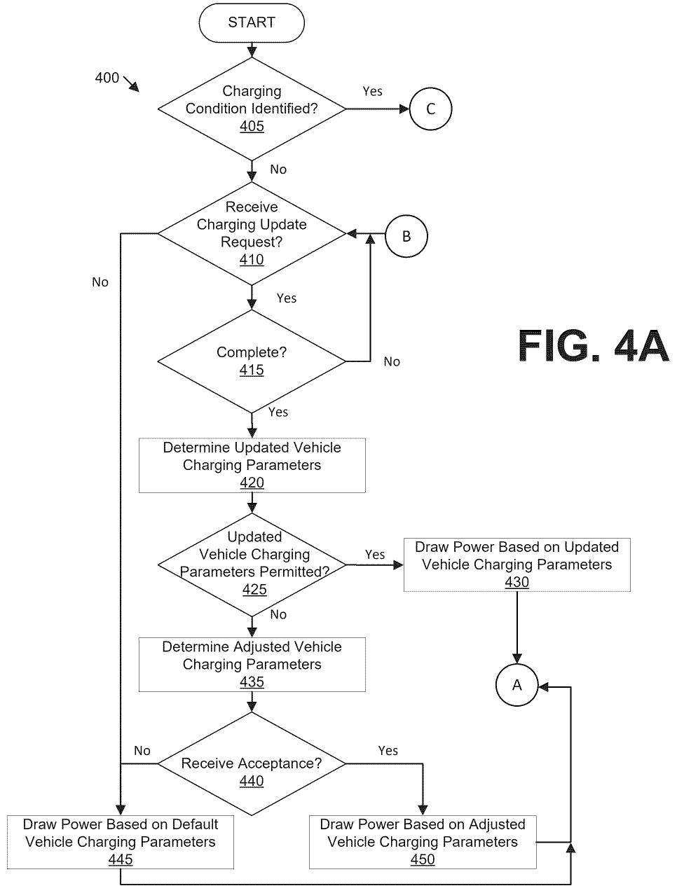

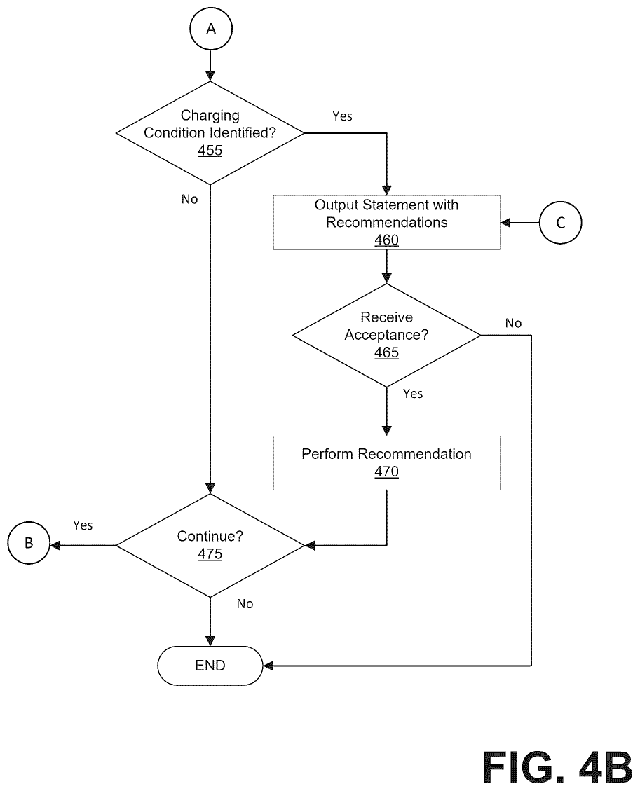

FIG. 4A is a first portion of a flow chart illustrating an exemplary process 400 (the second portion being shown in FIG. 4B because the entire flowchart will not fit on a single drawing sheet) for charging a vehicle 105 at a charging station 205. The process 400 begins in a block 405. The process 400 can be carried out by a vehicle computer 110 included in the vehicle 105, executing program instructions stored in a memory thereof.

In the block 405, the vehicle computer 110 determines whether a charging condition is present with the charging station 205. For example, the vehicle computer 110 can receive sensor 115 data upon entering a sub-area 220 adjacent to the charging station 205, as discussed above. The vehicle computer 110 can input the sensor 115 data into an LLM 300 trained to output text identifying a presence or an absence of a charging condition with the charging station 205. If a charging condition is present with the charging station 205, the process 400 continues in a block 460. Otherwise, the process 400 continues in a block 410.

In the block 410, the vehicle computer 110 determines whether a charging update request is received. For example, the vehicle computer 110 can detect an audio sample including speed from a user or a user input (e.g., via an HMI 118 or a user device) specifying the charging update request, as discussed above. The vehicle computer 110 can detect the charging update request prior to the vehicle 105 being connected to the charging station 205, prior to initiation of a charging operation, or after initiation of the charging operation, as discussed above. If the charging update request is received, then the process 400 continues in a block 415. Otherwise, the process 400 continues in a block 445.

In the block 415, the vehicle computer 110 determines whether the charging update request is complete or incomplete. The vehicle computer 110 can, for example, compare information included in the charging update request to various data stored in a look-up table, as discussed above. If the vehicle computer 110 determines that the information is associated with the various data, then the vehicle computer 110 determines that the charging update request is complete, and the process 400 continues in a block 420. If the vehicle computer 110 determines that the information is not associated with at least some of the data, then the vehicle computer 110 determines that the charging update request is incomplete. In this situation, the vehicle computer 110 actuates the HMI 118 to output a message requesting additional information, as discussed above. The process 400 then returns to the block 410.

In the block 420, the vehicle computer 110 determines updated vehicle charging parameters based on the complete charging update request. For example, the vehicle computer 110 can input the complete charging update request to the LLM 300 that outputs the updated vehicle charging parameters, as discussed above. The process 400 continues in a block 425.

In the block 425, the vehicle computer 110 determines whether the updated vehicle charging parameters are permitted for the charging station 205. As one example, the vehicle computer 110 can input the updated vehicle charging parameters, station charging parameters, an estimated battery 150 parameter(s), and/or an estimated charging end time to the LLM 300 that outputs text indicating whether the updated vehicle charging parameters are permitted or not permitted, as discussed above. If the updated vehicle charging parameters are permitted, then the process 400 continues in a block 430. Otherwise, the process 400 continues in a block 435.

In the block 430, the vehicle computer 110 draws power from the charging station 205 based on the updated vehicle charging parameters. That is, the vehicle computer 110 can actuate one or more components 125 to receive electricity from the charging station 205 according to the updated vehicle charging parameters, as discussed above. The process 400 continues in a block 455.

In the block 435, the vehicle computer 110 determines adjusted vehicle charging parameters. For example, the vehicle computer 110 can input the updated vehicle charging parameters, the station charging parameters, the estimated battery 150 parameter(s), and/or the estimated charging end time to the LLM 300 that outputs the adjusted vehicle charging parameters, as discussed above. The vehicle computer 110 can then output a recommendation statement, including the adjusted vehicle charging parameters, to the user, as discussed above. The process 400 continues in a block 440.

In the block 440, the vehicle computer 110 determines whether the user accepts the adjusted vehicle charging parameters. For example, the vehicle computer 110 can detect a response indicating acceptance (e.g., via the HMI 118 or the user device 145, as discussed above) of the recommendation statement, as discussed above. If the vehicle computer 110 detects the acceptance, then the process 400 continues in the block 450. Otherwise, the process 400 continues in the block 445. Alternatively, the process 400 may return to the block 435 to continue to refine the vehicle charging parameters.

In the block 445, the vehicle computer 110 draws power from the charging station 205 based on default vehicle charging parameters. That is, the vehicle computer 110 can actuate one or more components 125 to receive electricity from the charging station 205 according to the default vehicle charging parameters, as discussed above. The process 400 continues in a block 455.

In the block 450, the vehicle computer 110 draws power from the charging station 205 based on the adjusted vehicle charging parameters. That is, the vehicle computer 110 can actuate one or more components 125 to receive electricity from the charging station 205 according to the adjusted vehicle charging parameters, as discussed above. The process 400 continues in a block 455.

In the block 455, the vehicle computer 110 determines whether a charging condition is present with the charging station 205 or the vehicle 105. For example, the vehicle computer 110 can receive sensor 115 data while the vehicle 105 is connected to the charging station 205, as discussed above. The vehicle computer 110 can input the sensor 115 data into an LLM 300 trained to output text identifying a presence or an absence of a charging condition with the charging station 205 or the vehicle 105, as discussed above. If a charging condition is present, the process 400 continues in the block 460. Otherwise, the process 400 continues in a block 475.

Turning now to FIG. 4B, following the block 455 shown in FIG. 4A, in the block 460, the vehicle computer 110 outputs a statement with recommendations to resolve the charging condition. For example, the LLM 300 can output recommendations in addition to the identification of the charging condition, as discussed above. The vehicle computer 110 can provide the recommendations to the user (e.g., via the HMI 118 or the user device 145), as discussed above. The process 400 continues in a block 465.

In the block 465, the vehicle computer 110 determines whether the user accepts the recommendations. For example, the vehicle computer 110 can detect a response indicating acceptance (e.g., via the HMI 118 or the user device 145, as discussed above) of the recommendations provided in the block 460, as discussed above. If the vehicle computer 110 detects the acceptance, then the process 400 continues in the block 470. Otherwise, the process 400 ends.

In the block 470, the vehicle computer 110 performs the recommendation. For example, the vehicle computer 110 can identify another available charging station 205 based on the charging station 205 being the source of the charging condition, as discussed above. As another example, the vehicle computer 110 can determine to adjust the updated vehicle charging parameters based on the vehicle 105 being the source of the charging condition, as discussed above. The process 400 continues in the block 475.

In the block 475, the vehicle computer 110 determines whether to continue the process 400. For example, the vehicle computer 110 can determine not to continue when the vehicle 105 is disconnected from the charging station 205. Conversely, the vehicle computer 110 can determine to continue while the vehicle 105 is connected to the charging station 205. If the vehicle computer 110 determines to continue, the process 400 returns to the block 410. Otherwise, the process 400 ends.

In general, the computing systems and/or devices described may employ any of a number of computer operating systems, including, but by no means limited to, versions and/or varieties of the Ford Sync® application, AppLink/Smart Device Link middleware, the Microsoft Automotive® operating system, the Microsoft Windows® operating system, the Unix operating system (e.g., the Solaris® operating system distributed by Oracle Corporation of Redwood Shores, California), the AIX UNIX operating system distributed by International Business Machines of Armonk, New York, the Linux operating system, the Mac OSX and iOS operating systems distributed by Apple Inc. of Cupertino, California, the BlackBerry OS distributed by Blackberry, Ltd. of Waterloo, Canada, and the Android operating system developed by Google, Inc. and the Open Handset Alliance, or the QNX® CAR Platform for Infotainment offered by QNX Software Systems. Examples of computing devices include, without limitation, an on-board first computer, a computer workstation, a server, a desktop, notebook, laptop, or handheld computer, or some other computing system and/or device.

Computers and computing devices generally include computer-executable instructions, where the instructions may be executable by one or more computing devices such as those listed above. Computer executable instructions may be compiled or interpreted from computer programs created using a variety of programming languages and/or technologies, including, without limitation, and either alone or in combination, Java™, C, C++, Matlab, Simulink, Stateflow, Visual Basic, Java Script, Perl, HTML, etc. Some of these applications may be compiled and executed on a virtual machine, such as the Java Virtual Machine, the Dalvik virtual machine, or the like. In general, a processor (e.g., a microprocessor) receives instructions (e.g., from a memory, a computer readable medium, etc.) and executes these instructions, thereby performing one or more processes, including one or more of the processes described herein. Such instructions and other data may be stored and transmitted using a variety of computer readable media. A file in a computing device is generally a collection of data stored on a computer readable medium, such as a storage medium, a random access memory, etc.

Memory may include a computer-readable medium (also referred to as a processor-readable medium) that includes any non-transitory (e.g., tangible) medium that participates in providing data (e.g., instructions) that may be read by a computer (e.g., by a processor of a computer). Such a medium may take many forms, including, but not limited to, non-volatile media and volatile media. Non-volatile media may include, for example, optical or magnetic disks and other persistent memory. Volatile media may include, for example, dynamic random access memory (DRAM), which typically constitutes a main memory. Such instructions may be transmitted by one or more transmission media, including coaxial cables, copper wire and fiber optics, including the wires that comprise a system bus coupled to a processor of an ECU. Common forms of computer-readable media include, for example, RAM, a PROM, an EPROM, a FLASH-EEPROM, any other memory chip or cartridge, or any other medium from which a computer can read.

Databases, data repositories or other data stores described herein may include various kinds of mechanisms for storing, accessing, and retrieving various kinds of data, including a hierarchical database, a set of files in a file system, an application database in a proprietary format, a relational database management system (RDBMS), etc. Each such data store is generally included within a computing device employing a computer operating system such as one of those mentioned above, and are accessed via a network in any one or more of a variety of manners. A file system may be accessible from a computer operating system, and may include files stored in various formats. An RDBMS generally employs the Structured Query Language (SQL) in addition to a language for creating, storing, editing, and executing stored procedures, such as the PL/SQL language mentioned above.

In some examples, system elements may be implemented as computer-readable instructions (e.g., software) on one or more computing devices (e.g., servers, personal computers, etc.), stored on computer readable media associated therewith (e.g., disks, memories, etc.). A computer program product may comprise such instructions stored on computer readable media for carrying out the functions described herein.

With regard to the media, processes, systems, methods, heuristics, etc. described herein, it should be understood that, although the steps of such processes, etc. have been described as occurring according to a certain ordered sequence, such processes may be practiced with the described steps performed in an order other than the order described herein. It further should be understood that certain steps may be performed simultaneously, that other steps may be added, or that certain steps described herein may be omitted. In other words, the descriptions of processes herein are provided for the purpose of illustrating certain embodiments and should in no way be construed so as to limit the claims.

Accordingly, it is to be understood that the above description is intended to be illustrative and not restrictive. Many embodiments and applications other than the examples provided would be apparent to those of skill in the art upon reading the above description. The scope of the invention should be determined, not with reference to the above description, but should instead be determined with reference to the appended claims, along with the full scope of equivalents to which such claims are entitled. It is anticipated and intended that future developments will occur in the arts discussed herein, and that the disclosed systems and methods will be incorporated into such future embodiments. In sum, it should be understood that the invention is capable of modification and variation and is limited only by the following claims.

All terms used in the claims are intended to be given their plain and ordinary meanings as understood by those skilled in the art unless an explicit indication to the contrary in made herein. In particular, use of the singular articles such as “a,” “the,” “said,” etc. should be read to recite one or more of the indicated elements unless a claim recites an explicit limitation to the contrary.

What is claimed is:

1. A system, comprising a computer including a processor and a memory, the memory storing instructions executable by the processor to:
input, to a large language model, a charging update request for charging a vehicle by a charging station;
output, from the large language model, updated vehicle charging parameters based on the charging update request; and
upon determining that the charging update request is permitted for the charging station, draw power from the charging station based on the updated vehicle charging parameters.

2. The system of claim 1, wherein the instructions further include instructions to, upon determining that the charging update request is not permitted for the charging station, draw power from the charging station based on default vehicle charging parameters.

3. The system of claim 2, wherein the instructions further include instructions to output, from the large language model, an explanation statement identifying reasons the charging update request is not permitted.

4. The system of claim 1, wherein the instructions further include instructions to determine whether the charging update request is permitted for the charging station based on at least one of a charging end time and a vehicle battery parameter.

5. The system of claim 1, wherein the instructions further include instructions to identify, via the large language model, a charging condition based on vehicle sensor data.

6. The system of claim 5, wherein the instructions further include instructions to output, from the large language model, an explanation statement identifying that a source of the charging condition is the vehicle or the charging station.

7. The system of claim 6, wherein the instructions further include instructions to output, from the large language model, an identification statement identifying an unoccupied charging station based on the source being the charging station.

8. The system of claim 5, wherein the instructions further include instructions to adjust, via the large language model, the updated vehicle charging parameters based on the charging condition.

9. The system of claim 1, wherein the instructions further include instructions to:
upon determining that the charging update request is not permitted for the charging station, output, from the large language model, adjusted vehicle charging parameters based on the charging update request; and
output, from the large language model, a recommendation statement identifying the adjusted vehicle charging parameters.

10. The system of claim 9, wherein the instructions further include instructions to, upon inputting, to the large language model, a response indicating acceptance of the recommendation statement, draw power from the charging station based on the adjusted vehicle charging parameters.

11. A method, comprising:
inputting, to a large language model, a charging update request for charging a vehicle by a charging station;
outputting, from the large language model, updated vehicle charging parameters based on the charging update request; and
upon determining that the charging update request is permitted for the charging station, drawing power from the charging station based on the updated vehicle charging parameters.

12. The method of claim 11, further comprising, upon determining that the charging update request is not permitted for the charging station, drawing power from the charging station based on default vehicle charging parameters.

13. The method of claim 12, further comprising outputting, from the large language model, an explanation statement identifying reasons the charging update request is not permitted.

14. The method of claim 11, further comprising determining whether the charging update request is permitted for the charging station based on at least one of a charging end time and a vehicle battery parameter.

15. The method of claim 11, further comprising identifying, via the large language model, a charging condition based on vehicle sensor data.

16. The method of claim 15, further comprising outputting, from the large language model, an explanation statement identifying that a source of the charging condition is the vehicle or the charging station.

17. The method of claim 16, further comprising outputting, from the large language model, an identification statement identifying an unoccupied charging station based on the source being the charging station.

18. The method of claim 15, further comprising adjusting, via the large language model, the updated vehicle charging parameters based on the charging condition.

19. The method of claim 11, further comprising:
upon determining that the charging update request is not permitted for the charging station, outputting, from the large language model, adjusted vehicle charging parameters based on the charging update request; and
outputting, from the large language model, a recommendation statement identifying the adjusted vehicle charging parameters.

20. The method of claim 19, further comprising, upon inputting, to the large language model, a response indicating acceptance of the recommendation statement, drawing power from the charging station based on the adjusted vehicle charging parameters.
